(19) United States
(12) Patent Application Publication
(10) Pub. No.: US 2004/0054890 A1
(43) Pub. Date: Mar. 18, 2004

(54) Method for producing evidence of the transmittal and reception through a data transmission network of an electronic document and its contents

(76) Inventor: Francois-Joseph Vasseur, Paris (FR)

Correspondence Address: BACHMAN & LAPOINTE, P.C., 900 CHAPEL STREET, SUITE 1201, NEW HAVEN, CT, 06510, US

(21) Appl. No.: 10/380,363

(22) PCT Filed: Sep. 10, 2001
(86) PCT No.: PCT/FR01/02801

(30) Foreign Application Priority Data
Sep. 13, 2000 (FR) 00/11658

(51) Int. Cl. H04L 9/00; H04L 12/54

(52) U.S. Cl. 713/156; 370/428; 370/400

(57) ABSTRACT

The invention concerns a method for producing written evidence of the real date transmission and filing with a certification authority of an electronic document, in the form of a qualified certificate, the contents of the document being recorded on a tamperproof medium, for transmitting to a specified addressee in register mode said document bearing one's own electronic signature generated by the certification authority in accordance with a reliable identification procedure, and to obtain the proof of actual placement of the document with the addressee, formalized by an acknowledgement of placement issued by the authority, and in case of acceptance by the addressee, evidence of reception of the document by the addressee, constituted by a double qualified certificate, issued at real date by the certification authority and guaranteed by same, containing the signatures both parties and formalized by an electronic acknowledgement of receipt transmitted to the sender.

### BACKGROUND OF THE INVENTION

The present invention relates to a method for generating evidence of the transmission and reception through a data transmission network (through copper wire, optical fiber, radio waves, cable or any other equivalent medium, such as for example the Internet) of an electronic document and its contents.

According to the prior art, for obtaining. written evidence of the transmission and reception of a document (such as a deed under private seal, a registered letter or document, an official deed certified by a public officer), it is necessary to record the document to a paper medium and to use a distribution network adapted to this medium and modes of evidence are necessarily dependent on this medium and its constraints (physical travels, costs, slowness). There is no available method of electronic proof, in particular of a conventional nature, nor any method for generating registered documents in electronic form or any conventional solution as opposed to the inventive method, allowing to fulfil the validity conditions of a proof agreement, of a legal registered mail or an official deed, which in particular would be formalized by an electronic acknowledgement of receipt or placement on electronic documents and/or computer files in the form of a double qualified certificate, without this requiring any physical travel, in a quasi-instantaneous and permanently accessible manner.

### SUMMARY OF THE INVENTION

The present method allows one to dispense with the paper medium for creating legally admissible written evidence having the same value as a single, conventional or irrefutable presumption, which may also be used as an official registered mail or official deed according to the qualifications of the certification third party. In particular, this method uses encryption according to a specific organization of its applications, namely transmitting data and creating sites and portals in a secure mode, the advanced electronic signatures and the qualified certificates.

In summary, the present method of proof:

1/creates a written evidence of the real date network transmission and filing with a certification authority of an electronic document, in the form of a qualified certificate, and of the recording of its contents and attached files on a tamperproof, durable and non-modifiable medium,

2/transmits in registered mode said document bearing one's own advanced electronic signature generated according to a reliable identification procedure by the certification authority, the latter guaranteeing the link between said signature and the document, as well as its transmission under normal conditions to the specified addressee, and

3/obtains the written evidence of placement of said document with the addressee, formalized by an acknowledgment of placement issued by said authority, and in case of acceptance by the addressee, the conventional and irrefutable evidence of reception of the document and its contents by the addressee, constituted by a double qualified certificate, issued at real date by the certification authority and guaranteed by same, containing the signatures of both parties, which evidence is formalized as an electronic acknowledgment sent via the network to the sender.

In French law, the present method allows one to create either a written evidence as defined according to article 1316-1 of the Civil Code, and legally admitted with the provision, in case of contention, of an appreciation by the judiciary Power, or, in case of acceptance of the document by its addressee, to apply a proof agreement which is imposed upon a judiciary Power in accordance with article 1316-2 of the same Code, guaranteed by a third party, and within the frame of a public service mission, said method generating a registered document in the legal sense of this term (example: art. L. 122-14 of the Work Code: appointment for personal interview “by registered mail (L. N^{o} 86-1320 of Dec. 30th 1986)”, Intellectual Property Code, criminal procedure Code (notifications of an examining magistrate), telecommunications code, etc.). When the inventive method is set-up, implemented and guaranteed by an authority qualified as a public officer, the receipt or placement acknowledgements have probative force until a civilian or criminal plea of forgery, in contrast with single presumptions against which contrary evidence may by shown. In such a case, the product of the present method of registering, which in this case is said to be authenticated registration, has the value of an official deed.

In community law, specifically with regard to the EC Directive of the European Parliament and of the Council of Dec. 13, 1999 on the community framework for electronic signatures (hereafter the Directive), the present method, implemented by the certification authority (or the certification service provider in accordance with article 2(11) and incorporating a secure device for generating and verifying an advanced electronic signature in accordance with article 2 (2, 6 and 8), generates a double qualified certificate in accordance with article 2(10) of said Directive which, in accordance with article 5(b), is admissible by the jurisdictions of the member States and pertains to the characteristics of the transmission and contents of an electronic document signed by the sender, as well as to the certified receipt of the addressee or certified placement by the certification authority.

### BRIEF DESCRIPTION OF THE DRAWINGS

A more complete understanding of the present invention and advantages thereof may be obtained from consideration of the following description with reference to the definitions of terms given at the end thereof and the accompanying drawings in which:

FIGS. 1-3 are simplified flowcharts of the method according to a preferred embodiment of the present invention.

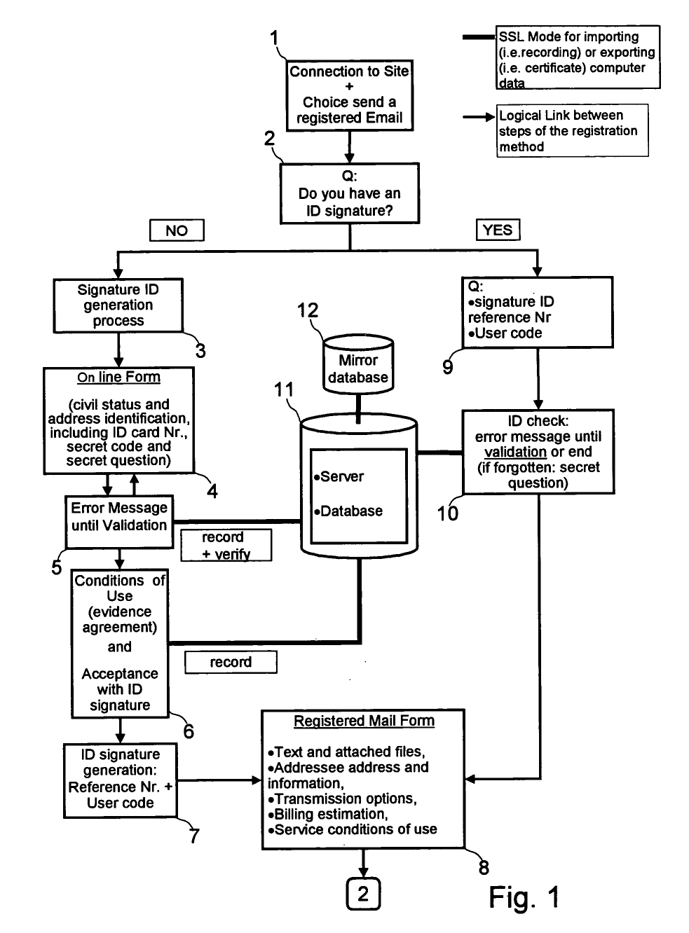

### DETAILED DESCRIPTION OF THE PREFERRED EMBODIMENT(S)

1. Connection

1.1. The Sender wishing to obtain an evidence of the transmission and receipt of an electronic document connects (step 1) to the Site from a work station, after having changed the electronic document desired to be sent in registered mode into a computer word processing file, along with any files to be attached to the mail.

1.2. Upon being connected, the Sender is notified that the whole site which he is about to enter is in secure mode and that the information collected within this registered mail service is required and subject to the protecting legislation of the CNIL (National Commission for Information and Liberty).

2. Welcome page

2.1. Functionally, the Sender may access through hypertext links, (i) general information about the registered e-mail service with the Conditions of Use and without any acceptance function and a Frequently Asked Questions database or “FAQ”, (ii) the service's directory, (iii) information about the certification Authority and its partners, (iv) the Registering function, “Send a registered e-mail”, (v) the Revocation function, “Revocation of identity Signature”, (vi) the function for creating an identity Signature and modifying features of an identity Signature, (vii) the cost of the registering service, and (viii) the legal environment and value of the registering.

For the contents of these functions, reference should be made to the Definitions.

2.2. For sending a registered e-mail, the Sender, by clicking the link “Sending a registered e-mail”, is directed to the page “Sending a registered e-mail”.

3. Sending a registered e-mail.

3.1. Identifying the Sender.

According to whether the person is either a non-referenced Sender (3.1.1.), or a User who therefore possesses an Identity Signature (3.1.2.), he/she is directed to the corresponding qualification, by being prompted to select the respective hypertext link (step 2).

3.1.1. Non-referenced sender: Process for Creating of his/her identity Signature (see Definitions) (steps 3-7).

3.1.2. User having an Identity Signature (steps 9 and 10). It should be noted that it is possible to place a direct link on this page from the welcome page. The User enters the information about his/her identity signature, namely the reference ID number of the identity Signature and a password. The corresponding information is displayed and the User is prompted to notify the Authority in case of later modification. In case of modification, a new validation of identifying data is carried out in the same manner as when the identity Signature was Created (see Definitions).

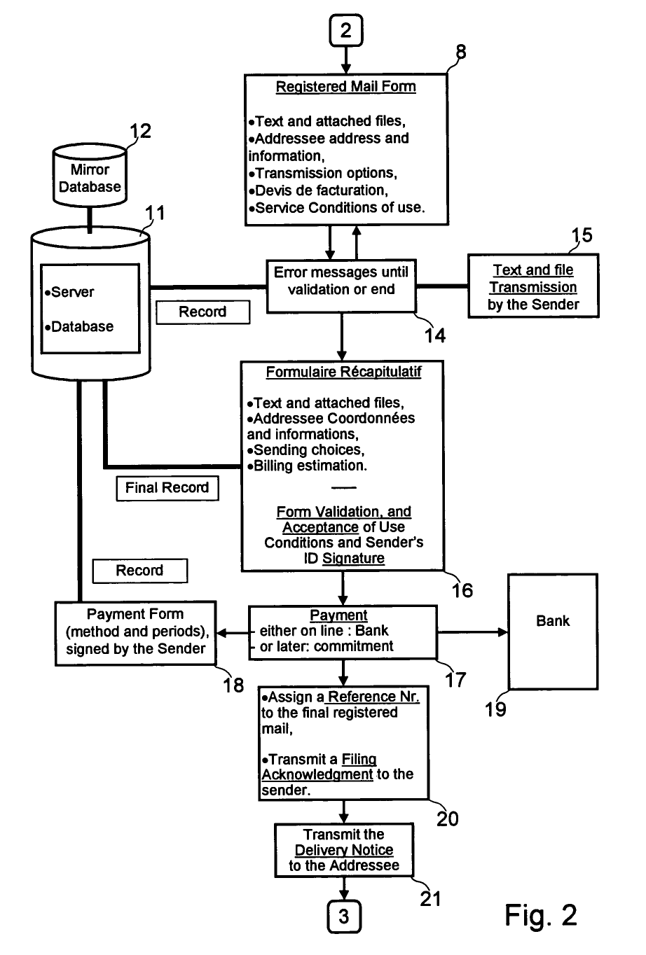

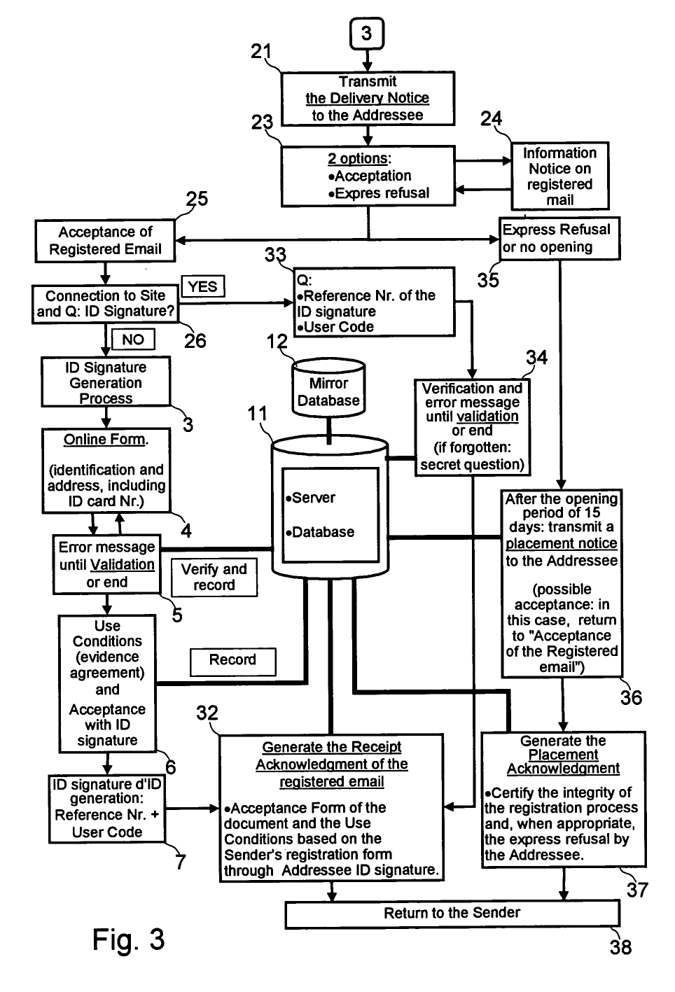

3.2. Creating a registered e-mail (steps 8 and 14 in FIG. 2).

This is carried out by means of a form having two parts, one relating to the Addressee (3.2.1.) and the other relating to the contents of the registered e-mail, its attached files and registering characteristics (3.2.2.).

3.2.1. Identifying the Addressee: The Authority requests the addressee's electronic address and checks it, on the one hand, against its Directory and on the other hand, when appropriate, against the database where this address is hosted or any useful database. In case of error or impossibility to refer to the addressee, an error message is displayed to the User, which shows the possible solutions: check the address that was entered, other reference, or other search of any web site or databases or cancellation or return to the welcome page (2.1.). The process is continued until the Addressee is found. It should be pointed out that the latter has not yet been contacted by the authority.

3.2.2. Contents of the registered e-mail: the Sender is asked either to enter directly within the field provided for that purpose the document to be registered, or to transmit the same as a word processing file or by using the copy and paste function, in which case said text is displayed within the same field and may be further modified. When the modifications, if any, are completed, the Sender may insert in another field the files to be attached to the mail, these being displayed with their complete file name. Afterwards, the Sender is asked whether the Receipt Acknowledgment and Delivery Notice should be sent through postal mail.

3.3. Service Validation, billing and payment (steps 16, 17 and 18).

3.3.1. Validation (step 16): Once these operations are completed, the Sender validates them as a whole, as well as the Conditions of Use, by affixing his/her Identity Signature and this data is recorded in the database 11 by the certification Authority with an additional recording in a mirror database 12 (cluster).

3.3.2. Billing (step 16): The certification Authority computes the amount which is owed by the user for the registered e-mail service as a function of the characteristics of the registered e-mail based on the costs displayed on the welcome page, and displays the result. At this time, the Sender may still refuse the invoice and cancel the whole registering process without this cancellation comprising the Identity Signature, which is separate from the process, but for which it is proposed to carry out its Revocation if the User wishes so. When accepting the invoice, the Sender is directed, according to his/her choice, either to the secure billing site for an immediate payment (3.3.3.1.), or to a differed payment commitment (3.3.3.2.).

3.3.3. Payment (step 17).

3.3.3.1. Immediate online payment: the site is secure and managed by an organization 19, which is authorized in the sense of the banking law, and operates based on the number and the validity date of a credit card.

3.3.3.2. Differed payment commitment: the Sender is committed to pay the amount owed within the specified time frame, either as a bank check or a bank wire transfer, and sets his/her identity Signature on said commitment (step 18).

3.4. Recording and referencing the registered e-mail and Transmitting the filing Acknowledgment (steps 16 and 20).

3.4.1. Final recording (step 16): The Authority records in its database 11 all of the information collected on a tamperproof, durable and non-modifiable medium and carries out the same recording within a mirror database 12 having the same security characteristics, but offline.

3.4.2. Generating a number for referencing the registered e-mail, transmitted to the Sender in the filing acknowledgment (step 20).

3.4.3. Generating the filing Acknowledgment (see Definitions) and transmitting it to the Sender (step 20).

3.5. Sending to the Addressee (step 21).

3.5.1. Creating the Delivery Notice: The certification Authority generates a secure e-mail bearing its signature and serving as a certificate, in the form of an electronic message.

3.5.2. The Delivery Notice is sent to the Addressee via the Internet network, i.e. intermediaries abiding by security standards allowing for satisfactory transmission or, when appropriate, by the certification Authority itself.

4. Notification and generation of Receipt or Placement Acknowledgments.

4.1. Notification: the Addressee receives in his/her electronic mailbox an email message, marked as highly important and secure, named “Delivery Notice relating to a registered e-mail” and exclusively addressed to the Addressee, holder of said electronic address, and signaled by an icon showing the Authority's or Intermediary's logo. By clicking on this electronic mail, the addressee is notified of the fact that he/she is the addressee of a registered e-mail available on the Authority's Site through its hypertext link, that he/she may either obtain more information by clicking “more info” (4.2.), or accept the message by clicking “Accept the registered e-mail” (4.3.), or refuse by clicking “refuse the registered email” (4.4.) (step 23).

4.2. Complementary information (step 24): an explanation is provided to the Addressee, on the one hand, about the objective and status of the registering service and on the other hand, about an alternate solution that may be chosen, namely:

either accept the registered e-mail and obtain for that purpose a free Identity signature, which may be reused for authenticating his/her messages, specifying that accepting the registered e-mail implies express authorization of the certification Authority to state, in a receipt Acknowledgment provided to the Sender, the full and total acceptance at real date of the contents of the document and its attachments by the Addressee, to preserve this information for 30 years and to communicate it upon legal ruling.

or refuse the registered e-mail, in which case he/she will be notified that this registered document may be accepted during an opening period of two weeks, at the expiry of which he/she will be sent a Placement Notice from which he/she will be assumed to have had retroactive knowledge of the registered document since the date of the delivery Notice. In any case, the registered document remains available to the Addressee and may still be accepted and opened after the opening Period, but with the provision that the validity of receipt date validity is expressly recognized on the day of the delivery Notice.

Finally, the Addressee is prompted with a direct link to the Site's Welcome page and to the Site's General Information.

4.3. Acceptance of the registered e-mail (step 25):

The Addressee clicks the icon “Accept registered e-mail” and reaches the page of Site that relates to the Acceptance of registered e-mails, where he/she should specify that he/she is a User and already has an Identity Signature (4.3.1) or, if this is not the case (4.3.2), he/she will be directed to the page “Create the Receipt Acknowledgment” (4.3.3.) (step 26).

4.3.1. The Addressee is a User: he/she is requested to specify the number of his/her identity Signature and secret code (step 33). The Authority checks this information against its database 12 (step 34). If the verification succeeds, the Addressee is directed to the page for creating the Receipt Acknowledgement (step 32).

4.3.2. Creation of the Addressee's identity Signature (steps 3-7): the Addressee is directed to the identity Signature Creation page (cf. Definitions) similarly to 3.1.1. After the step 7, the addressee, which has now also become a User and after having accepted the Conditions of Use, goes to the Receipt Acknowledgment Creation page (step 32).

4.3.3. Creation of the receipt Acknowledgement (step 32): this a Form which displays the addressee's characteristics and the reference number of the registered e-mail. At this stage, it is still possible to cancel the acceptance process and, if applicable, the identity Signature generated by the revocation service. Based on this form, the Addressee accepts in a definite and irrevocable manner the registered e-mail by affixing his/her identity signature, according to the proof agreement contained in the Conditions of Use accepted when creating the identity Signature.

4.3.4. Final Recording of the receipt Acknowledgment (step 32): the Authority records in its database 12 all of the information collected on a tamperproof, durable and non-modifiable medium and carries out the same recording in a mirror database having the same security features, but offline.

4.3.5. Opening of the registered e-mail by the Addressee, the latter being able to download the same to his/her workstation if desired, noting that the registered document will still be accessible with the certification Authority by specifying the reference number of the registered e-mail and the Addressee's identity Signature.

4.4. Refusal of the registered e-mail (steps 35-37).

4.4.1. Refusal (step 36): The Addressee who does not wish to accept the registered e-mail may click the icon “refuse registered e-mail”. The Authority automatically issues a message which notifies him/her: (1) of the possibility of later accepting, within an opening time period of 15 days starting from the date when this Notice is sent, and mentioning that the document remains available for this purpose on the certification Authority's Site, (2) that in any case, once the opening period expires, a Placement Acknowledgment will be sent, from which date he/she will be deemed to have been made aware of said registered e-mail which will nevertheless remain at his/her disposal.

4.4.2. No opening (step 36): once the opening period has expired, the Placement Notice of item 4.4.3. is sent. Upon request, it is optionally possible to contact the Addressee through other means or to obtain certification through intermediaries in charge of this transmission.

4.4.3. Issuing a Placement Notice (step 36): Once the opening period has expired, the Authority sends a Placement Notice, which reiterates the terms of the Delivery Notice but declares that the Addressee is deemed to have been made aware retroactively of the registered e-mail starting from the date of delivery Notice and that said presumption will be formalized in a Placement Acknowledgment sent to the Sender and legally admissible as a written evidence.

4.5. Creation by the Certification Authority of a Placement Acknowledgement of the electronic document (step 37): the certification Authority, in a first step, records all of the information collected in its database on a tamperproof, durable and non-modifiable medium and carries out the same recording in a mirror database having the same security features, but offline and, in a second step, issues based from this Authenticated Information, a single qualified certificate constituting the Placement Acknowledgment. Said Acknowledgment may, when appropriate, mention the express refusal by the Addressee to accept the registered email.

5. Sending the Receipt or Placement Acknowledgment (step 38).

5.1. Receipt Acknowledgement: the certification Authority transmits to the Sender, via the network, the receipt Acknowledgment (see Definitions), with the possible additional sending, if specifically requested, of a postal mail or fax transmission.

5.2. Placement Acknowledgement: the certification Authority transmits to the Sender, via the network, the Placement Acknowledgment (see Definitions), with the possible additional sending of a postal mail or fax.

End of the registration process.

For the needs of the present invention, the following definitions are applicable and are referred to by terms having an initial uppercase letter:

Electronic receipt Acknowledgement: The legally admissible evidence that the addressee of a registered e-mail has expressly accepted its reception, which acceptance is formalized by affixing his/her identity Signature. The value of this evidence is based up on a previously accepted evidence agreement within an organized and/or controlled framework by the certification Authority and, in the present proof method, inserted within the Conditions of use.

Formally, this receipt acknowledgement is in the form of an e-mail or electronic message comprising a double qualified certificate generated by the certification Authority and including (1) the registered document and its attached files corresponding to the delivery Notice (first qualified certification containing the evidence agreement signed by the Sender), (2) the electronic receipt Acknowledgment as such, which includes the Addressee's identity Signature irrevocably attached to said document (second qualified certificate, a replica of the second one but further including the same evidence agreement which is now signed by the Sender) and (3) the certificate of the certification Authority bearing this double certificate (1+2) and, when appropriate, its public Certificate. Upon request, the receipt Acknowledgment is doubled with a paper mail bearing the manual signature of a designated official of the Authority.

Legal Value: in French law, the electronic receipt Acknowledgment as generated by the present method, is a proof established in accordance with an evidence agreement which is imposed to the judiciary Power and against which no contrary evidence can be shown, in particular by waiving any dispute of the registering procedure, which is the main contractual duty in the evidence agreement. In community law and in particular, when applying the Directive, the electronic receipt Acknowledgment is composed of two certificates qualified in the sense of article 2 (10) of the Directive, which is admissible by the jurisdictions of member States, in accordance with article 5(b) of the Directive.

Filing Acknowledgment: this is the single qualified Certificate generated by the certification Authority and guaranteeing all characteristics of the registered email (including the document, the addressee, the evidence agreement and the Sender's signature), registered so as to guarantee integrity on a reliable, durable, and tamperproof medium, according to the best state of the art. This filing Acknowledgment is sent electronically to the Sender and remains available to the same or the judiciary Power to serve as a proof of the contents at real date of the filing of a registered mail and its characteristics.

Placement Acknowledgment: following the Placement Notice, this is the proof that the Addressee was brought into a position to accept and therefore access the registered document in order to be made aware of its contents. This Placement Acknowledgment, which is a single qualified certificate, implies a simple presumption that the document is known by the Addressee starting from before the delivery Notice. The Placement Acknowledgment is sent to the Addressee by the same method as the receipt Acknowledgment. A Placement Acknowledgment may further comprise, when appropriate: (1) the indication of express refusal by the Addressee of the registered e-mail proving that he/she was in a position to accept the same, and (2) the certification by the intermediaries involved in the transmission, that the delivery Notice has duly been sent to the Addressee's electronic address.

Legal value: In French law, the Placement Acknowledgment is a written evidence in accordance with Article 1316-1 of the Civil Code, legally admissible and having a value of single presumption against which the opposite evidence may be shown. In community law, in particular in accordance to the Directive, the electronic receipt Acknowledgment, which is composed of a single qualified certificate in accordance with Article 2(10) of the Directive, is admissible by the jurisdictions of member States in accordance with article 5(b) of the Directive.

Placement Notice: this designates the reiteration of the Delivery Notice, complemented with a clear warning as to the consequences of refusal to open, in particular with regard to the presumption of knowledge. Previously to the Placement Acknowledgment, this ends the opening period and starts the single knowledge presumption starting from the mailing date of the Delivery Notice.

Legal Value: in French law the Placement Notice is a written evidence in accordance with Article 1316-1 of the Civil Code, certified by a third party, and legally admissible but only having the value of a single presumption against which the opposite evidence can be shown. In community law and in particular with regard to the Directive, said Notice is a qualified Certificate in the sense of article 2(10) of the Directive, which is admissible by the jurisdictions of member States in accordance with article 5(b) of the Directive.

Electronic Delivery Notice: this is an e-mail sent to the Addressee via the Internet network, namely by intermediaries abiding by satisfactory transmission security standards, or when applicable, by the certification Authority itself. The delivery Notice is electronically signed by the certification Authority for the Sender. This e-mail is marked as being highly important and is signaled in particular by an icon representing the Authority's logo.

By clicking this electronic mail, the addressee is notified that he/she is the addressee of a registered e-mail which is available on the Authority's Site through its hypertext link, that he/she may either obtain information (see section 4.2 of the description), or accept the message (see 4.3. of the description), or refuse the same (see 4.4. of the description), these various choices corresponding to hypertext links to the relevant pages of the site.

Legal value: Sets the starting date of the opening Period and, as a consequence of the Placement Notice marks the starting point of the presumption of knowledge.

In French law, the Delivery Notice is a written evidence is certified by a third party in accordance with article 1316-1 of the Civil Code, which is only legally admissible as a single presumption against which opposing evidence may be shown. In community law, and in particular, with regard to the Directive, said Notice is a qualified certificate in the sense of article 2(10) of the Directive, admissible by the jurisdictions of the member States in accordance with article 5(b) of the Directive.

Certification Authority: designates the body that organizes an guarantees the present proof method, and in particular, the exactness of the information contents of the evidence items provided, namely the Identity Signature, filing Notice, delivery Notice, Placement Notice, and the either of the receipt Placement Acknowledgments by issuing single and/or double qualified certificates pertaining to the relevant deeds.

The certification Authority organizes the creation and verification of the identity Signatures by means of a secure creation and verification device insuring the incumbent's identification reliability, recording and archival with secure procedures on a durable and non-modifiable medium, the integrity of which is guaranteed, of the registered e-mails and their contents, the transfer and placement with the addressees of the registered e-mails and the sending back of either the receipt Acknowledgment or the Placement Acknowledgment.

The certification Authority, whether of private or public legal status, for the registration service, shows reliability guarantees in general and in particular by employing qualified and skilled personnel both for management, technical implementation and encryption of electronic signatures, single or double qualified certificates and appropriate security procedures, by applying management administrative procedures and methods conforming to recognized standards, by ensuring a directory service, an archival service available to the judiciary power or upon request by the concerned users (sender and addressee), and a cancellation service, by checking the User's, identity, and by making sure that proper measures are taken against counterfeit, by appropriately ensuring that the collected information is confidential, by having sufficient financial resources and damage insurance, in particular with regard to registering service liability to the Users, by recording relevant information as to the evidence provided in order to maintain the same available to the judiciary power and the concerned users, by taking care of informing the Users through durable communication means about the modalities and conditions of use of the registering service, and by using reliable systems for storing the issued certificates in a verifiable form, so that only authorized persons may enter and change data, information may be checked for authenticity, certificates are made available to the public only in case of acceptance by the incumbent and that any modification imperiling these security requirements are made apparent to the operator.

Qualified certificate (single double. public):

Single: designates an electronic certification which links data pertaining to the advanced electronic signature verification to a person, confirms the identity of said person and the link between the signature and the document which bears it.

Double: specific to the present registering method. Designates the qualified certificate of a certification Authority pertaining to two advanced electronic signatures (see identity Signatures), in particular those of the Sender and the Addressee, which are attached to a single set of documents particularly comprised of: (1) an electronic document and/or computer files, (2) an evidence agreement linking the parties as to this method of proof (see Conditions of Use) and (3) conditions under which this set of documents is transmitted. From a technical point of view, the Authority generates two certificates in the form of single qualified Certificates according to the most up-to-date existing techniques for that purpose, so that their gathering according to the present method of proof, forms the Double qualified certificate.

Public: designates simple or double certificates, but issued within the frame of a public service mission.

Conditions of use: designates the rules governing the registering service, including an evidence agreement, which all Users must accept and abide to in order to obtain and preserve their qualification as a User, as well as to give full effect to the instrumentalities generated upon request by the present method of proof.

These conditions affect the present method, the guarantees provided by the certification Authority and the commitments which the Users abide by. This contract contains the evidence agreement, which is agreed upon consecutively, through and under the control of the certification Authority, by the Sender and the Addressee when creating their Identity Signature and using the registered e-mail service, wherein all parties irrevocably waive any dispute as to the perfect validity of the proofs generated by the registering process. In particular, they waive any action whatsoever against the registering process itself, its instrumentalities and products, among which specifically the identity Signatures, among which those of the parties and of future incumbents, and the Notices and Acknowledgements issued by the certification Authority. Also, the parties guarantee the exactness of the information which they have provided the certification Authority. Finally, in case of acceptance of the registered e-mail after the opening period, the Addressee expressly recognizes retroactively, through a clause added to that effect in the conditions of use, the validity of the receipt date at which the delivery Notice was issued.

Each registering service is an application of this evidence agreement, which binds the parties and is imposed to the judiciary Power, specifically in French law (article 1316-2 of the Civil Code).

Opening Period: This is the period (for example) of two weeks during which the sender may choose between accepting or refusing the registered e-mail. This period starts from the date of sending of the Delivery Notice to the Addressee and ends by the sending of the Placement Notice. When it expires, the addressee is deemed to have had knowledge of the registered e-mail since the delivery Notice.

Addressee: The person, whether physical or corporate, receiving an electronically signed Delivery Notice from the certification Authority.

If he/she chooses to acknowledge receipt of the registered e-mail, the Addressee becomes a User of the registering service bound by an evidence agreement with the Sender.

If he/she refuses or in case of non opening of the registered e-mail, he/she will be deemed to have been made aware of it after expiry of the opening period, which is a single presumption established by the Placement Acknowledgment following the Placement Notice.

Directive: The EC Directive of the Parliament and Council on the community framework for electronic signatures of Dec. 14, 1999, N^{o} 1999/93/CE, JOCE 19/01/2000, N^{o}L 13, p. 12.

Registered e-mail: A document signed electronically by the Sender and sent to the Addressee by the certification Authority.

State: the sovereign authority of a law system, specifically in charge of public authentication. This State may be one of the member States of the European Union applying the Directive or a State outside the EC bound by a recognition treaty in that matter or its equivalent. The State is to be understood both as a public administration and as local governments or their equivalent making up the same.

Sender: The physical or corporate person, author of a registered e-mail resorting to a registering service.

Placement: The presumption borne by the Addressee after having sent the Placement Notice and retroactively from the date of the Delivery Notice, according to which he/she is deemed to have been made aware of the registered e-mail, thus bringing the document contents into effect. For that purpose, the certification Authority guarantees that all appropriate means have been implemented for informing the Addressee that a registered e-mail has been sent to him/her and he/she should legally accept it by means of an advanced electronic signature, free of charge and individually identifying him/her, to open the registered e-mail. In any case, the registered document remains at his/her disposal and may still be accepted and opened after the opening Period, but with the provision that the receipt date's validity is expressly recognized on the date of the delivery Notice.

Legal value: A single presumption of knowledge of the registered e-mail which may be opposed by a contrary proof. This presumption is materialized by the Placement Acknowledgement serving as a written evidence in French law and as a qualified certificate in community law.

Registering: The service provided by the present method, which may both be private or public according to the nature of the certification Authority's functions.

Revocation: This is the process ending the validity of the electronic signature, unbinding the User from the identity Signature. The revoked identity Signatures are no longer guaranteed by the certification Authority. At the outcome, the deeds affected previously to the revocation in accordance to the revoked signature remain valid and archived, and bind the User. Afterwards, the revoked Signature will not be assigned to anyone and will remain archived at the disposal of the User having revoked it, but in a passive form: the user may no longer use it and the revoked Signature is no longer valid for identifying said User.

Registering Service: designates the implementation of the method of proof described in the present invention.

Identity Signature: A data item in electronic form identifying unambiguously its assignee by the use of a secure and reliable identification method over which the holder has an exclusive control, guaranteeing his/her binding with the deed bearing same, through the use of secure devices adapted to ensure integrity of said link and to maintain archives that may be consulted by the relevant users or the judiciary Power during the validity period of the relevant deed. Said signature is unique to each individual who is committed to use it for an exclusive personal purpose and not for commercial purposes, as well as preserving the integrity and confidentiality with regard to any third party other than the public certification Authority or as required by legal ruling. This identity Signature is non-transmissible, whether through gift or inheritance, and non-transferable. The electronic signature creation service may be charged or free of charge without its validity being jeopardized. However, according to the present invention, the identity Signature assigned to the Addressee should be free of charge for the sole purpose that he/she may acknowledge receipt of the registered e-mail.

Technical aspects and legal value: The identity Signature is counterfeit-proof, unchangeable, traceable, and certified by a third party through the use of any appropriate technical means. The present invention does not deal with advanced electronic signatures or certificates as such, but uses the same according to the best state of the art provided that it fulfills the national or community validity criteria. However, illustratively, said means may be applied mathematical processes for protecting confidentiality and ensuring authentication of the data in the message in question by overwriting or transforming the same into a modified version liable to be converted back into original data using the appropriate encryption algorithm and key, all of which is aimed at concealing the contents of messages, preventing modifications and avoiding illegal uses. Thus, in the present state of the art, its implementation may be a pair of mathematically related encryption keys composed of a private part (a mathematical key kept secret by the User and used for signing an electronic message and, according to the algorithm, to decrypt messages or files encrypted with the corresponding public key) and a public part (a mathematical key, which may be made public, and is used for verifying the electronic signatures generated by means of the corresponding private key; according to the algorithm, the public keys may also serve to encrypt messages or files which will later be decrypted with the corresponding private key), in particular with a condensation function (an algorithm for organizing or translating a set of bits into another one so that (1) a message gives the same result each time the algorithm is applied to the same message, (2) it is mathematically impossible to derive or reconstitute the message from the result of the applied algorithm, (3) it is mathematically impossible to find two different messages leading to the same condensed result with the same algorithm). In any case, and whatever the technique used for the present method of proof, the Identity Signature is unchangeably linked to the data collected when Creating the identity Signature, and to the reference number used by the certification Authority and the User's secret code.

However, the evolution of techniques, in particular encryption technology, precludes any technical standardization that might later become obsolete. As a consequence, it is appropriate to refer to the requirements set out in the above-mentioned texts, which take this constraint into account.

The Directive requires that the advanced electronic signature fulfil the following criteria: to be uniquely linked to the signatory and allow him/her to be identified, to be created by means that the signatory may maintain under his/her exclusive control and to be linked to the data it is related to so that any later modification of data may be detectable. Under these conditions, the advanced electronic signatures are admissible as a legal proof under the responsibility of member States, just as are the identification Signatures issued according to the present method of proof.

Article 1316-4 relating to the electronic signature requires the use of a reliable identification process guaranteeing its link with the deed bearing it. A Decree will define the conditions pertaining to the creation of the signature, the signatory's identification and the integrity of the deed that has been brought into effect so as to benefit from a single presumption. In any case, the regulation power is bound to fulfil the criteria set out in the Directive. As a consequence, and independently from the contents of the forthcoming Decree, the conditions of which will be immediately taken into account according to French law, an electronic signature fulfilling the Directive's conditions—and as a consequence, an identity Signature issued in accordance with the present method of proof—is legally admissible.

Creating an identity signature (steps 3-7): The User shall communicate the following data, which are distinguished according to whether a physical or corporate person is concerned (step 4):

physical person: (i) number of identity card, passport, resident or refugee card, or any other number publicly identifying the User with a State, (ii) his/her civil status, namely his/her name and first name, place and date of birth, names and date and place of birth of User's parents (optional), electronic address, resident's address and telephone number (optional), as well as the secret code desired and the secret question in case the code is forgotten (i.e.: date of birth of a parent).

corporate person: (i) corporate name, (ii) corporate status, capital stock and registration number with the member State (Commercial Registration Number (RCS) filed with the competent commercial court or equivalent for commercial companies), (iii) address and telephone number (optional) of the registered office, (iv) authorized representative, namely his functions, qualifications, civil status reduced to the name, first name, and ID card number or equivalent, as well as the desired secret code and secret question in case the code is forgotten.

This information is controlled, when appropriate, by means of the connection to an appropriate external databank (step 5).

In case of error or incompatibility, the User is prompted, through an error message asking him/her to continue or stop, to re-input the data which were wrong or incompatible. The process is continued until abortion or total success. In the latter case, the information is once again checked against the appropriate databank.

The collected data is guaranteed as exact by the User who expressly declares he/she is the sole responsible for its exactness and frees the Authority, in case of error or falsity, of any resulting consequences. For that purpose, the User should validate the information displayed on the web page.

After this validation, the User should check and accept the Conditions of Use. In particular, he/she is bound not to refute neither the registering process nor its products, and specifically the identity Signatures, among which his/her own and those of his/her future correspondents, and the Notices and Acknowledgements given by the Authority (step 6).

Based on this data, the certifications carried out and the acceptance of Conditions of Use, the certification Authority creates the identity Signature by creating a double key and requests the User to provide the desired secret code along with its validation and secret question (step 7).

The certification Authority notifies the User of the characteristics of the identity signature, namely: the number of the identity signature, its creation date, determined or undetermined duration and legal value.

Site: The Site is the certification Authority's web site. The Site is entirely secure so as to ensure a total confidentiality of information contained therein, transmitted thereto and archived thereat.

User: Designates users of the registering service, whether the Sender or the Addressee, so long as the latter accepts the conditions of use, for receiving the registered e-mail. The qualification as a User assumes a legal personality and legal capacity, in particular with regard to the evidence agreement included in the Conditions of use.

1. A method for generating evidence relative to transmission of an electronic document between a sender and an addressee equipped with respective computers both having access to a same data transmission network, said method being characterized in that it comprises the steps of:
transmitting an electronic document, including transmitting in a secure mode the electronic document to a certification authority also equipped with a computer connected to the transmission network, said transmission being carried out in combination with an addressee's electronic address and an electronic signature identifying in a irrefutable manner the document sender, wherein the sender has previously adhered to an evidence agreement through which he/she waives any dispute as to the validity of said signature and the documents generated by this method, and bearing this signature,
archiving carried out by the certification authority, including secure recording of the electronic document, the sender's electronic signature, assigning the document an identification code, and sending to the sender an electronic message acknowledging filing of the document containing the identification code assigned to the document,
sending a delivery notice message to the document addressee, by the certification authority, this step comprising sending to the addressee an electronic delivery notice message indicating the document identification code and that the latter will be available for a predefined placement period,
sending the document to the addressee by the certification authority, carried out by the certification authority provided the document receipt is accepted by the addressee following receipt of the delivery notice message, which step comprises transmitting the document to the addressee, and sending to the sender a receipt acknowledgment message containing an indication that the addressee has received the document along with an electronic signature, identifying in a irrefutable manner the addressee and guarantying that the addressee has accepted to receive the document, wherein the addressee has previously accepted an evidence agreement through which he/she will waive any dispute as to the validity of said signature and documents generated by this method, and bearing this signature, and
refusing the document, carried out in case the addressee refuses to receive the document or has not accepted the latter until the end of the predetermined period, which step includes sending by the certification authority to the sender a notice of placement of said document.

2. A method according to claim 1, further comprising a previous step whereby the certification authority assigns the sender an electronic signature including a member of an official identity card, which step comprises acceptance by the sender of the evidence agreement through which he/she waives any dispute as to the validity of said signature and documents generated by this method, which bears said signature, and stores in a database accessible to the computer of said certification authority, a sender's identification information and own password.

3. A method according to claim 1 or 2, characterized in that, previously to accepting the document sent by the addressee, it comprises a step whereby the certification authority assigns the addressee an electronic signature including a number of an official identification card, which step comprises acceptance by the addressee of the evidence agreement through which he/she waives any dispute as to the validity of the signature and the documents generated by said method, which bear said signature, and storing in a database accessible to the computer of the certification authority, a addressee's identification information and own password.

4. A method according to any of claims 1 to 3, characterized in that the acknowledgment message further contains the transmitted document and the delivery notice with the sender's electronic signature, all of which form with the addressee's signature a double certificate authenticated by the certification authority.

5. A method according to any of claims 1 to 4, characterized in that the placement notice message contains an indication for determining whether the document addressee has expressly refused to receive the document or has not requested the document during the predefined placement period.

6. A method according to any of claims 1 to 5, characterized in that the document comprises a plurality of computer files of any size and contents, to which is applied the same authentication.

7. A method according to any of claims 1 to 6, characterized in that the document, as well as the filing notice, delivery notice, placement notice and reception acknowledgment messages are recorded in an unchangeable manner on a tamperproof and durable medium, and in a protected mirror data base, which is not accessible through the data transmission network.

8. A method according to any of claims 1 to 7, characterized in that the data transmitted by the sender to the certification authority comprises information input into an online electronic form and attached files, which form is supplemented by information transmitted by the addressee if the latter accepts to receive the document, all of which form, with the sender's and addressee's electronic signatures, the receipt acknowledgment.

9. A method according to any of claims 1 to 8, characterized in that the transmission between the sender, the certification authority and the addressee are carried out in a SSL secure mode with an encryption protection against any fraudulent use of data.

10. A method according to any of claims 1 to 9, characterized in that the delivery notice message is either anonymous or contains the sender's name and, when appropriate, a document title.
